(19) United States
(12) Patent Application Publication
(10) Pub. No.: US 2009/0132842 A1
(43) Pub. Date: May 21, 2009

(54) Managing Computer Power Consumption In A Computer Equipment Rack

(75) Inventors: Thomas M. Brey, Cary, NC (US); Raymond M. Clemo, Raleigh, NC (US); Beth F. Loebach, Raleigh, NC (US); Gregory J. McKnight, Chapel Hill, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/940,896

(22) Filed: Nov. 15, 2007

(51) Int. Cl. G06F 1/32

(52) U.S. Cl. 713/322

(57) ABSTRACT

Methods, systems, and computer program products are provided for managing power consumption of computing devices in a computer equipment rack. Embodiments include monitoring aggregate power consumption of a plurality of computing devices in the computer equipment rack; determining whether the aggregate power consumption exceeds a predetermined maximum threshold; if the aggregate power consumption exceeds the predetermined maximum threshold, selecting a number of computing devices for throttling in dependence upon priority; and throttling-down the selected computing devices computing devices, reducing the aggregate power consumption to a level below the predetermined maximum threshold. Some embodiments may also include determining whether the aggregate power consumption is below a predetermined minimum threshold; if the aggregate power consumption is below the predetermined minimum threshold, selecting a number of computing devices computing devices computing devices for throttling in dependence upon priority; and throttling-up the selected computing devices, increasing the aggregate power consumption to a level above the predetermined minimum threshold.

### BACKGROUND OF THE INVENTION

1. Field of the Invention

The field of the invention is data processing, or, more specifically, methods, apparatus, and products for managing power consumption of computing devices in a computer equipment rack.

2. Description Of Related Art

Conventional computer equipment racks include many computing devices and all of those computing devices consume power. Because power is a significant expense managing power is an important consideration for systems administrators of computer equipment racks. Another important consideration for systems administrators of computer equipment racks is that often current safety regulations preclude configuring the computing devices of the computer equipment rack such that the total maximum power consumption may exceed the input circuit power available. Under such safety regulations it is not possible to oversubscribe the circuit power by configuring a number of computing devices such that total power may be greater than the total circuit. There is therefore an ongoing need for improvement in managing power consumption of computing devices in a computer equipment rack.

### SUMMARY OF THE INVENTION

Methods, systems, and computer program products are provided for managing power consumption of computing devices in a computer equipment rack. Embodiments include monitoring aggregate power consumption of a plurality of computing devices in the computer equipment rack, each of the computing devices being supplied power individually from a shared circuit in the computer equipment rack; determining whether the aggregate power consumption exceeds a predetermined maximum threshold; if the aggregate power consumption exceeds the predetermined maximum threshold, selecting a number of computing devices for throttling in dependence upon priority; and throttling-down the selected computing devices, reducing the aggregate power consumption to a level below the predetermined maximum threshold. Some embodiments may also include determining whether the aggregate power consumption is below a predetermined minimum threshold; if the aggregate power consumption is below the predetermined minimum threshold, selecting a number of computing devices for throttling in dependence upon priority; and throttling-up the selected computing devices, increasing the aggregate power consumption to a level above the predetermined minimum threshold.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for managing power consumption of computing devices in a computer equipment rack according to embodiments of the present invention.

FIG. 2 sets forth a block diagram of automated computing machinery comprising an exemplary power consumption managing computer useful in managing power consumption of computing devices in a computer equipment rack according to embodiments of the present invention.

FIG. 3 sets forth a flow chart illustrating an exemplary method for managing power consumption of computing devices in a computer equipment rack according to embodiments of the present invention.

FIG. 4 sets forth a flow chart illustrating an exemplary flow chart illustrating establishing the maximum threshold in dependence upon power objectives for the computer equipment rack.

FIG. 5 sets forth a flow chart illustrating additional exemplary aspects of a method for managing power consumption of computing devices in a computer equipment rack according to embodiments of the present invention that includes throttling-up selected computing devices.

### DETAILED DESCRIPTION OF EXEMPLARY EMBODIMENTS

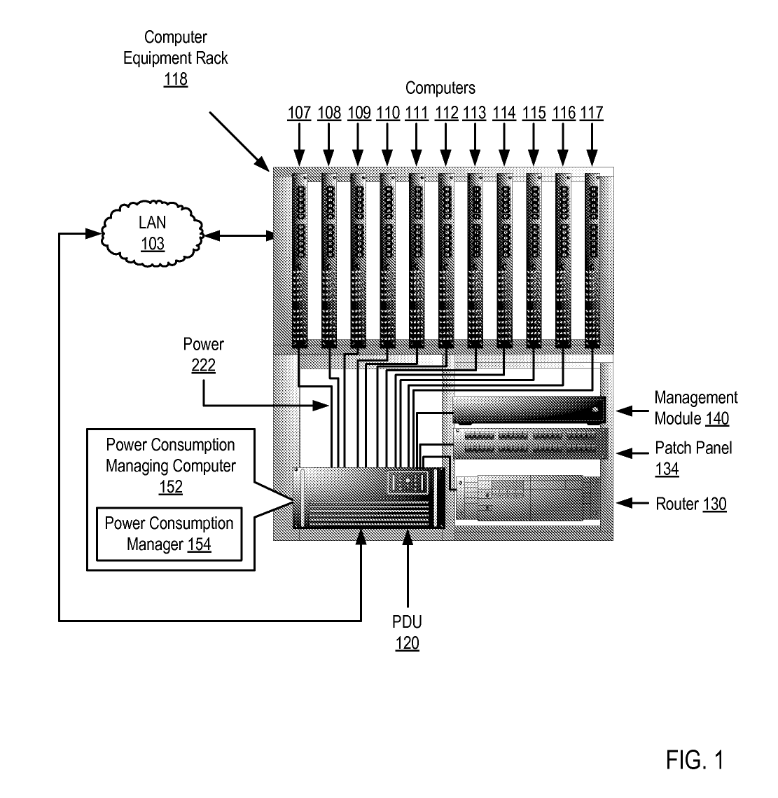

Exemplary methods, systems, and products for managing power consumption of computing devices in a computer equipment rack in accordance with the present invention are described with reference to the accompanying drawings, beginning with FIG. 1. FIG. 1 sets forth a network diagram of a system for managing power consumption of computing devices in a computer equipment rack according to embodiments of the present invention. The system of FIG. 1 includes a computer equipment rack (118). A computer equipment rack is a system for mounting various computing devices in a stack. Some conventional computer equipment racks are 19 inches wide and are divided into subracks. Each subrack is typically measured in rack units. Each rack unit, designated as ‘1U,’ is 1.75 inches in height. As an example, a typical rack may be a 19 inch, 24U rack, that is, 19 inches wide with 24, 1.75 inch high subracks. Typical computer equipment racks may include such computing devices as servers, network switches, routers, power supplies, power distribution units, management modules, and other electronic modules as will occur to those of skill in the art. The exemplary computer equipment rack (118) of FIG. 1, for example, includes a management module (140) used by a system administrator to configure and manage computing devices installed in the rack (118), a patch panel (134), and a router (130).

The computer equipment rack (118) of FIG. 1 includes a plurality of prioritized computers (107-117) connected to a power consumption managing computer (152) in the power distribution unit (‘PDU’) (120) through a local area network (‘LAN’) (103). The plurality of computers are prioritized for throttling-down or throttling-up to manage power consumption in the computer equipment rack. The plurality of computers may be prioritized dynamically in dependence upon current operating conditions such as applications currently running on each computer, tasks of an executing application currently running on each computer, and so on as will occur to those of skill in the art. The plurality of computers alternatively may be previously prioritized and such priorities may remain static until the computers are re-prioritized.

In addition to the computers, some other computer devices in the computer equipment rack of FIG. 1 may be prioritized for throttling-down or throttling-up. Some network routers, switches, and other computing devices as will occur to those of skill in the art in the art, for example, may be capable of throttling for power consumption. Some computing devices in the computer equipment rack, however, may not have throttling capabilities and instead draw a constant, or near-constant, amount of power from the power supply. In either case, the aggregate power of all computing devices, whether capable of being throttled or not, is monitored in accordance with embodiments of the present invention. All computing devices capable of being throttled are connected through LAN (103) to the power management computer.

In the example of FIG. 1 each of the computing devices (107-117, 140, 134, 130) is being supplied power (222) individually from a shared circuit in the computer equipment rack (118) that receives a shared power supply. That is, each computing device is independently supplied power from a common circuit receiving shared electrical supply (not shown in FIG. 1) within the computer equipment rack.

The example of FIG. 1 also includes a power distribution unit (120). The power distribution unit (120) of FIG. 1 has a dedicated circuit for measuring the aggregate power consumption of the computing devices in the computer equipment rack and providing the measured aggregate power consumption (120) to a power consumption manager (154). In the exemplary power distribution unit (120) of FIG. 1 the dedicated circuit for measuring the aggregate power consumption may be part of the power consumption managing computer (152). The power consumption managing computer (152) is shown as part of the PDU (120) of FIG. 1 for clarity, not for limitation. Readers of skill in the art will immediately recognize that such power consumption managing computer (152) may be implemented as a device external to the PDU such as, for example, a standalone electronic module installed in the computer equipment rack (118) connected to the PDU through the LAN.

The power consumption managing computer (152) of FIG. 1 has installed upon it a power consumption manager (154), computer program instructions for managing power consumption of computing devices in the computer equipment rack (118) according to embodiments of the present invention. The power consumption manager (154) includes computer program instructions that are capable of monitoring aggregate power consumption of a plurality of computing devices (107-117) in the computer equipment rack (118); determining whether the aggregate power consumption exceeds a predetermined maximum threshold; if the aggregate power consumption exceeds a predetermined maximum threshold, selecting a number of computing devices for throttling in dependence upon priority; and throttling-down the selected computers, reducing the aggregate power consumption to a level below the predetermined maximum threshold.

The power consumption manager (154) of FIG. 1 also includes computer program instructions capable of continuing to monitor the aggregate power consumption of the plurality of computing devices in the computer equipment rack (118); determining whether the aggregate power consumption is below a predetermined minimum threshold; if the aggregate power consumption is below a predetermined minimum threshold, selecting a number of computing devices for throttling in dependence upon priority; and throttling-up the selected computing devices, increasing the aggregate power consumption to a level above the predetermined minimum threshold.

The arrangement of computing devices making up the exemplary system illustrated in FIG. 1 is for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

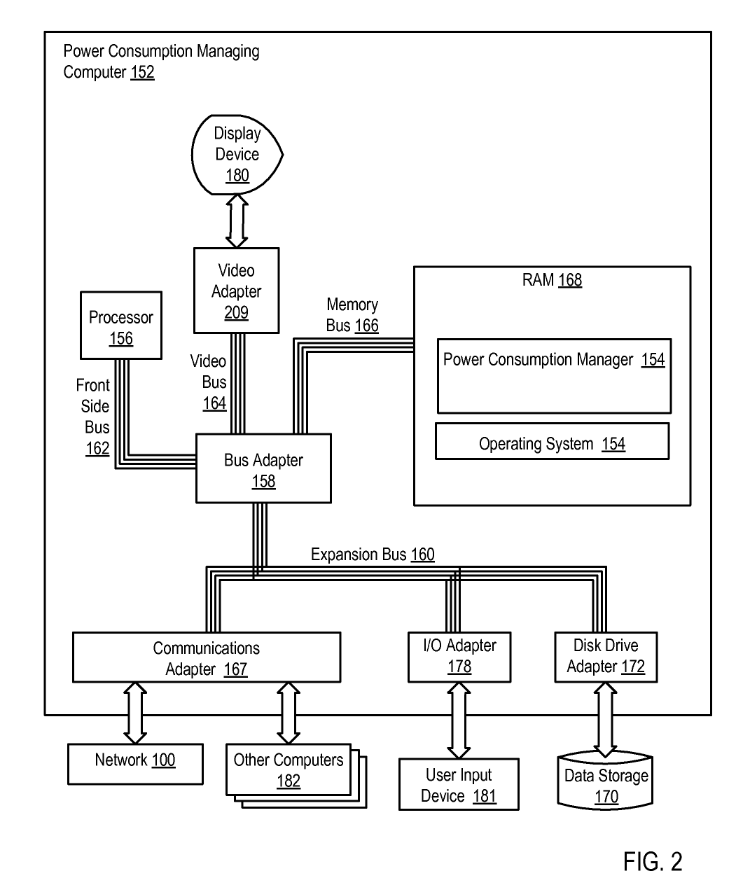

Managing power consumption of computing devices in a computer equipment rack in accordance with the present invention is generally implemented with computers, that is, with automated computing machinery. For further explanation, therefore, FIG. 2 sets forth a block diagram of automated computing machinery comprising an exemplary power consumption managing computer (152) useful in managing power consumption of computing devices in a computer equipment rack according to embodiments of the present invention. The power consumption managing computer (152) of FIG. 2 includes at least one computer processor (156) or ‘CPU’ as well as random access memory (168) (‘RAM’) which is connected through a high speed memory bus (166) and bus adapter (158) to processor (156) and to other components of the power consumption managing computer (152).

Stored in RAM (168) is a power consumption manager (154), a module of computer program instructions for managing power consumption of computing devices in a computer equipment rack in accordance with embodiments of the present invention. The power consumption manager (154) includes computer program instructions capable of monitoring aggregate power consumption of a plurality of computing devices in the computer equipment rack; determining whether the aggregate power consumption exceeds a predetermined maximum threshold; if the aggregate power consumption exceeds a predetermined maximum threshold, selecting a number of computing devices for throttling in dependence upon priority; and throttling-down the selected computing devices, reducing the aggregate power consumption to a level below the predetermined maximum threshold. The power consumption manager (154) of FIG. 2 also includes computer program instructions capable of determining whether the aggregate power consumption is below a predetermined minimum threshold; if the aggregate power consumption is below a predetermined minimum threshold, selecting a number of computing devices for throttling in dependence upon priority; and throttling-up the selected computing devices, increasing the aggregate power consumption to a level above the predetermined minimum threshold.

Also stored in RAM (168) is an operating system (154). Operating systems useful in managing power consumption of computing devices in a computer equipment rack according to embodiments of the present invention include UNIX™, LinUX™, Microsoft XP™, AIX™, IBM's i5/OS™, and others as will occur to those of skill in the art. The operating system (154) and power consumption manager (154) in the example of FIG. 2 are shown in RAM (168), but many components of such software typically are stored in non-volatile memory also, such as, for example, on a disk drive (170).

The power consumption managing computer (152) of FIG. 2 includes disk drive adapter (172) coupled through expansion bus (160) and bus adapter (158) to processor (156) and other components of the power consumption managing computer (152). Disk drive adapter (172) connects non-volatile data storage to the power consumption managing computer (152) in the form of disk drive (170). Disk drive adapters useful in computers for managing power consumption of computing devices in a computer equipment rack according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example power consumption managing computer (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example power consumption managing computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary power consumption managing computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for managing power consumption of computing devices in a computer equipment rack according to embodiments of the present invention include modems for wired dial-up communications, Ethernet (IEEE 802.3) adapters for wired data communications network communications, and 802.11 adapters for wireless data communications network communications.

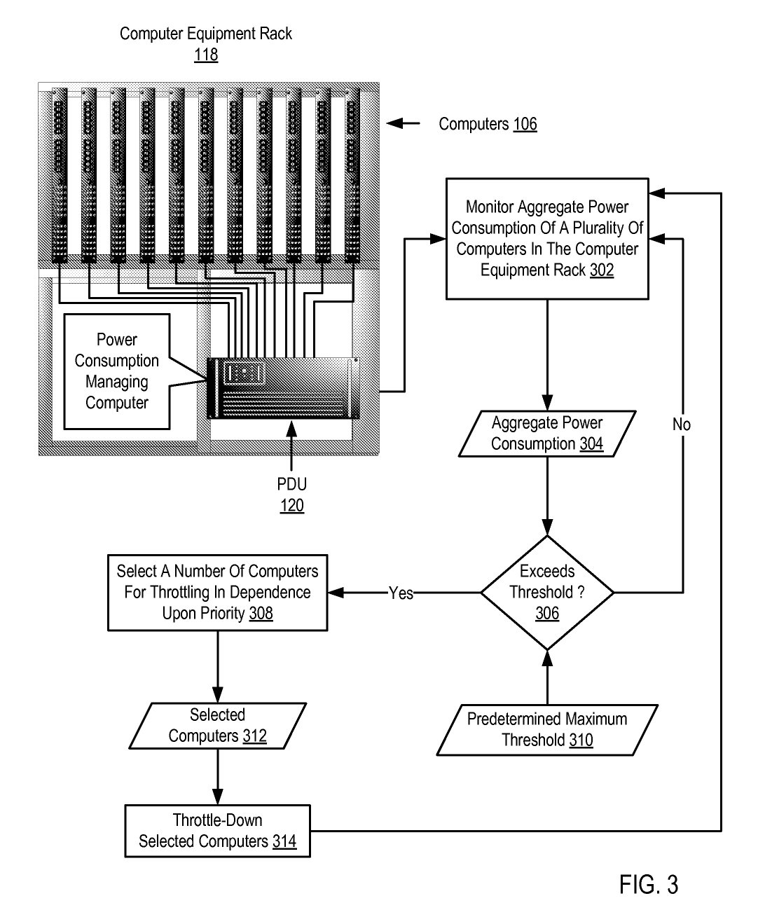

For further explanation, FIG. 3 sets forth a flow chart illustrating an exemplary method for managing power consumption of computing devices in a computer equipment rack according to embodiments of the present invention. In the example of FIG. 3 each of the computing devices has independent power supply within the computer equipment rack from the PDU (120). That is, each computing devices is independently supplied power from a common circuit within the equipment rack.

The method of FIG. 3 includes monitoring (302) aggregate power consumption (304) of a plurality of computing devices in the computer equipment rack (118). Monitoring (302) aggregate power consumption (304) of a plurality of computing devices in the computer equipment rack (118) may be carried out by receiving the measurement of power consumption from the power distribution unit (120) in the computer equipment rack. Such a power distribution unit may include dedicated power measuring circuits that measure power consumption and such power distribution units may include or be connected for data communications to a power consumption manager which aggregates all the power consumption values of all the computing devices being monitored.

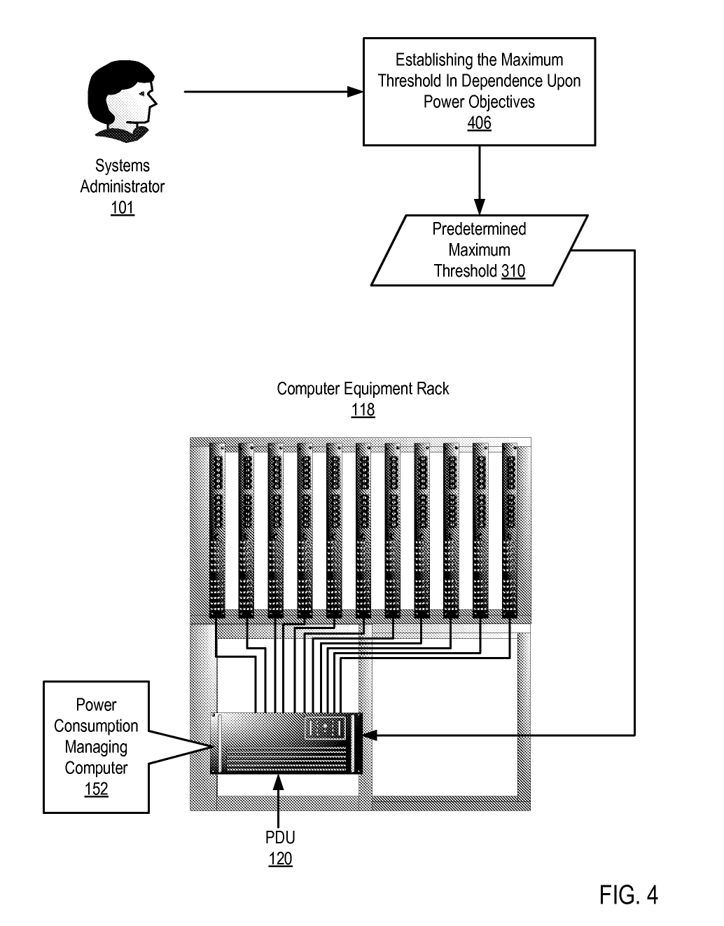

The method of FIG. 3 includes determining (306) whether the aggregate power consumption (304) exceeds a predetermined maximum threshold (310). Determining (306) whether the aggregate power consumption (304) exceeds a predetermined maximum threshold (310) may be carried out by comparing the aggregate power consumption with the predetermined maximum threshold. Such a predetermined maximum threshold may be established by a systems administrator of the computer equipment rack to meet power objectives of the computer equipment rack as discussed below with reference to FIG. 4.

If the aggregate power consumption (304) does not exceed a predetermined maximum threshold (310), the method of FIG. 3 continues to monitor the aggregate power consumption of the computing devices of the computer equipment rack (118). If the aggregate power consumption (304) exceeds a predetermined maximum threshold (310), the method of FIG. 3 includes selecting (308) a number of computing devices (312) for throttling in dependence upon priority. Selecting (308) a number of computing devices (312) for throttling in dependence upon priority may be carried out by selecting a number of computing devices in dependence upon data processing value rules. Data processing value rules are rules established to select computing devices for throttling such that the throttling-down of those computing devices has the least effect on the computational ability of the computer equipment rack. In some cases, data processing value rules may dictate that a certain computing devices already designated as low priority are to be throttled-down when the aggregate power consumption exceeds the predetermined maximum threshold.

Alternatively, data processing value rules may be configured for dynamic selection of computing devices for throttling. Such data processing value rules are capable of assigning priorities to the computing devices of the computer equipment rack in dependence upon the applications currently running on the computing devices and selecting a number of computing devices in dependence upon the assigned priorities. Assigning priorities to the computing devices of the computer equipment rack in dependence upon the applications currently running on the computing devices may include assigning priorities in dependence upon the kind of application running on the computing devices, the actual computations currently being carried out by the computing devices, or other application attributes as will occur to those of skill in the art.

The method of FIG. 3 includes throttling-down (314) the selected computing devices (312). Throttling-down the selected computing devices may be carried out by reducing the CPU clock speed of one or more of the selected computing devices. Throttling-down the selected computing devices also may be carried out by reducing the data communications bus clock speed of one or more of the selected computing devices. Data communications bus clock speeds that may be reduced to throttle-down the selected computing devices include I/O bus clock speeds, memory bus clock speeds, and so on as will occur to those of skill in the art.

After throttling-down (314) the selected computing devices (312), the method of FIG. 3 continues to monitor the aggregate power consumption of the computing devices in the computer equipment rack. The method of FIG. 3 may be carried out iteratively until throttling-down selected computing devices results in reducing the aggregate power consumption to a level below the predetermined maximum threshold (310).

The method of FIG. 3 allows the highest priority computing devices to be protected from throttling unless lower priority computing devices have already been throttled to their maximum allowed rate as determined by the computer equipment rack systems administrator. This technique protects the use of the high priority computing devices as best as possible within the constraints of the predetermined power usage limits.

For further explanation, FIG. 4 sets forth a flow chart illustrating an exemplary flow chart illustrating establishing (406) the maximum threshold (310) in dependence upon power objectives for the computer equipment rack. Establishing (406) the maximum threshold (310) in dependence upon power objectives for the computer equipment rack in the example of FIG. 4 is carried out by a systems administrator (101) of the computer equipment rack (118) to meet one or more power objectives of the computer equipment rack and a power consumption manager installed on the power consumption managing computer (152) is capable of receiving such an established predetermined maximum threshold. Power objectives may include energy consumption objectives to reduce total energy consumption of the computer equipment rack thereby reducing total costs spent on energy. Power objectives may also take into consideration physical limitations set by the physical implementation of the computer equipment rack. That is, there may be a maximum power that can be delivered by the wired infrastructure of the computer equipment rack.

Power objectives may also include oversubscription objectives. Oversubscription of a power circuit occurs when the possible aggregate power consumption of the computing devices powered by the circuit of the computer equipment rack exceeds the rating of the circuit powering the computing devices. Establishing a threshold below the rating of the power circuit allows the circuit to be oversubscribed with computing devices whose aggregate maximum power consumption otherwise could exceed the rating of the circuit and also provides the needed protection for the circuit. That is, if the aggregate power consumption of the computing devices in the computer equipment rack does not exceed the predetermined threshold the power circuit the operation of the computing devices will remain unaffected regardless of the subscription level of the computer equipment rack and if the aggregate power consumption of the computing devices in the computer equipment rack does exceed the predetermined threshold selected computing devices will be throttled-down.

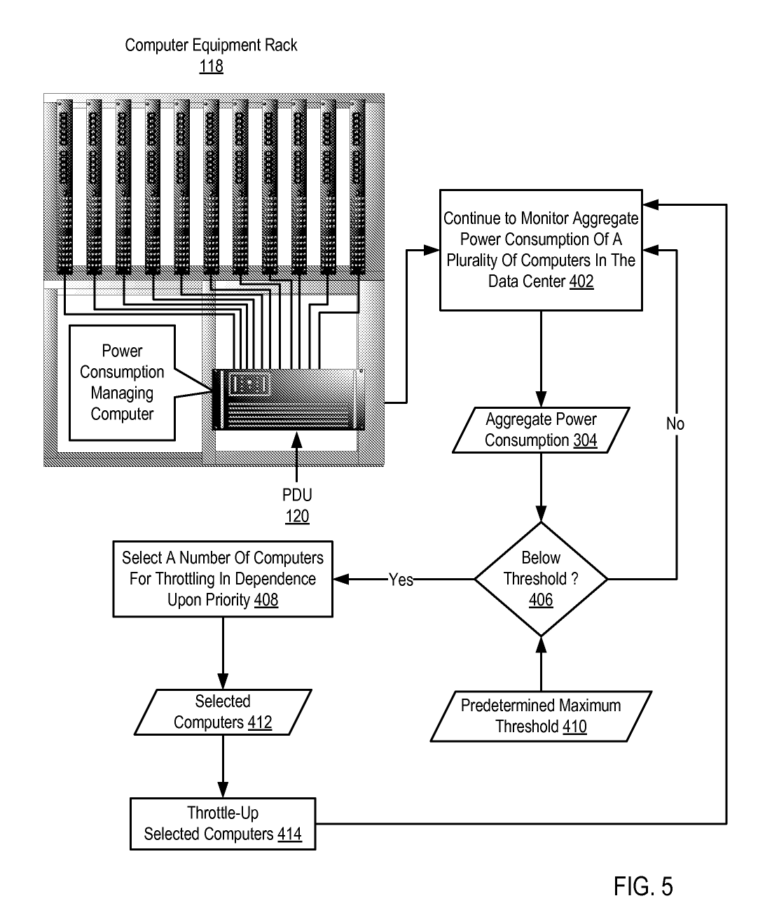

Once the aggregate power consumption of the computing devices of the computer equipment rack has been reduced below the predetermined maximum threshold, continuing the operation of throttled-down computing devices may result in unnecessary energy conservation at the expense of productivity of the computer equipment rack. For further explanation, therefore, FIG. 5 sets forth a flow chart illustrating additional exemplary aspects of a method for managing power consumption of computing devices in a computer equipment rack according to embodiments of the present invention that includes throttling-up selected computing devices. The method of FIG. 5 includes continuing to monitor (402) the aggregate power consumption (304) of the plurality of computing devices in the computer equipment rack and determining (406) whether the aggregate power consumption (406) is below a predetermined minimum threshold (410). Determining (406) whether the aggregate power consumption (406) is below a predetermined minimum threshold (410) may be carried out by comparing the aggregate power consumption with the predetermined minimum threshold. Such a predetermined minimum threshold may be established by a systems administrator of the computer equipment rack to meet power objectives of the computer equipment rack in the same manner as discussed above with reference to FIG. 4.

If the aggregate power consumption (304) is below a predetermined minimum threshold (410), the method of FIG. 5 includes selecting (408) a number of computing devices (412) for throttling in dependence upon priority. Selecting (408) a number of computing devices (412) for throttling in dependence upon priority may be carried out by selecting a number of computing devices in dependence upon data processing value rules as discussed above with reference to FIG. 3. Such data processing value rules may dictate the same set of computing devices or a different set of computing devices for throttling-up than the computing devices selected for throttling-down according to the method of FIG. 3.

In some cases, data processing value rules may dictate that a certain computing devices already designated as high priority are to be throttled up when the aggregate power consumption exceeds the predetermined minimum threshold. Alternatively, data processing value rules may be configured for dynamic selection of computing devices for throttling as mentioned above with reference to FIG. 3.

The method of FIG. 5 also includes throttling-up (414) the selected computing devices (412). Throttling-up the selected computing devices may be carried out by increasing the CPU clock speed of one or more of the selected computing devices, increasing the data communications bus clock speeds of one or more of the selected computing devices, or in other ways as will occur to those of skill in the art.

After throttling-up (414) the selected computing devices (312), the method of FIG. 3 continues to monitor the aggregate power consumption of the computing devices in the computer equipment rack. The method of FIG. 4 may be carried out iteratively until throttling-up the selected computing devices results in increasing the aggregate power consumption to a level above the predetermined minimum threshold (410).

Exemplary embodiments of the present invention are described largely in the context of a fully functional computer system for managing power consumption of computing devices in a computer equipment rack. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for managing power consumption of computing devices in a computer equipment rack, the method comprising:
monitoring aggregate power consumption of a plurality of computing devices in the computer equipment rack, each of the computing devices being supplied power individually from a shared circuit in the computer equipment rack;
determining whether the aggregate power consumption exceeds a predetermined maximum threshold;
if the aggregate power consumption exceeds the predetermined maximum threshold, selecting a number of computing devices for throttling in dependence upon priority; and
throttling-down the selected computing devices, reducing the aggregate power consumption to a level below the predetermined maximum threshold.

2. The method of claim 1 further comprising:
determining whether the aggregate power consumption is below a predetermined minimum threshold;
if the aggregate power consumption is below the predetermined minimum threshold, selecting a number of computing devices for throttling in dependence upon priority; and
throttling-up the selected computing devices, increasing the aggregate power consumption to a level above the predetermined minimum threshold.

3. The method of claim 1 wherein throttling-down the selected computing devices further comprises reducing a CPU clock speed of one or more of the selected computing devices.

4. The method of claim 1 wherein throttling-down the selected computing devices further comprises reducing a data communications bus clock speed of one or more of the selected computing devices.

5. The method of claim 1 wherein selecting a number of computing devices for throttling in dependence upon priority further comprises selecting a number of computing devices in dependence upon data processing value rules.

6. The method of claim 1 further comprising establishing the maximum threshold in dependence upon power objectives for the computer equipment rack.

7. A system for managing power consumption of computing devices in a computer equipment rack, the apparatus comprising a computer processor, a computer memory operatively coupled to the computer processor, the computer memory having disposed within it computer program instructions capable of:
monitoring aggregate power consumption of a plurality of computing devices in the computer equipment rack, each of the computing devices being supplied power individually from a shared circuit in the computer equipment rack;
determining whether the aggregate power consumption exceeds a predetermined maximum threshold;
if the aggregate power consumption exceeds the predetermined maximum threshold, selecting a number of computing devices for throttling in dependence upon priority; and
throttling-down the selected computing devices, reducing the aggregate power consumption to a level below the predetermined maximum threshold.

8. The system of claim 7 wherein the computer memory also has disposed within it computer program instructions capable of:
determining whether the aggregate power consumption is below a predetermined minimum threshold;
if the aggregate power consumption is below the predetermined minimum threshold, selecting a number of computing devices for throttling in dependence upon priority; and
throttling-up the selected computing devices, increasing the aggregate power consumption to a level above the predetermined minimum threshold.

9. The system of claim 7 wherein computer program instructions capable of throttling-down the selected computing devices further comprise computer program instructions capable of reducing a CPU clock speed of one or more of the selected computing devices.

10. The system of claim 7 wherein computer program instructions capable of throttling-down the selected computing devices further comprise computer program instructions capable of reducing a data communications bus clock speed of one or more of the selected computing devices.

11. The system of claim 7 wherein computer program instructions capable of selecting a number of computing devices for throttling in dependence upon priority further comprise computer program instructions capable of selecting a number of computing devices in dependence upon data processing value rules.

12. The system of claim 7 wherein the computer memory also has disposed within it computer program instructions capable of receiving the maximum threshold in dependence upon power objectives for the computer equipment rack.

13. A computer program product for managing power consumption of computing devices in a computer equipment rack, the computer program product disposed in a computer readable medium, the computer program product comprising computer program instructions capable of:
monitoring aggregate power consumption of a plurality of computing devices in the computer equipment rack, each of the computing devices being supplied power individually from a shared circuit in the computer equipment rack;
determining whether the aggregate power consumption exceeds a predetermined maximum threshold;
if the aggregate power consumption exceeds the predetermined maximum threshold, selecting a number of computing devices for throttling in dependence upon priority; and
throttling-down the selected computing devices, reducing the aggregate power consumption to a level below the predetermined maximum threshold.

14. The computer program product of claim 13 further comprising computer program instructions capable of:
determining whether the aggregate power consumption is below a predetermined minimum threshold;
if the aggregate power consumption is below the predetermined minimum threshold, selecting a number of computing devices for throttling in dependence upon priority; and
throttling-up the selected computing devices, increasing the aggregate power consumption to a level above the predetermined minimum threshold.

15. The computer program product of claim 113 wherein computer program instructions capable of throttling-down the selected computing devices further comprise computer program instructions capable of reducing a CPU clock speed of one or more of the selected computing devices.

16. The computer program product of claim 13 wherein computer program instructions capable of throttling-down the selected computing devices further comprise computer program instructions capable of reducing a data communications bus clock speed of one or more of the selected computing devices.

17. The computer program product of claim 13 wherein computer program instructions capable of selecting a number of computing devices for throttling in dependence upon priority further comprise computer program instructions capable of selecting a number of computing devices in dependence upon data processing value rules.

18. The computer program product of claim 13 further comprising computer program instructions capable of receiving the maximum threshold in dependence upon power objectives for the computer equipment rack.

19. The computer program product of claim 13 wherein the computer readable medium comprises a recordable medium.

20. The computer program product of claim 13 wherein the computer readable medium comprises a transmission medium.
